(19) United States
(12) Patent Application Publication
(10) Pub. No.: US 2010/0253942 A1
(43) Pub. Date: Oct. 7, 2010

(54) METHOD AND DEVICE FOR CHARACTERIZING SILICON LAYER ON TRANSLUCENT SUBSTRATE

(75) Inventors: Konrad Mack, Essingen (DE); Juergen Gobel, Jena (DE); Joerg Wagner, Jena (DE)

Correspondence Address: FISH & RICHARDSON PC, P.O. BOX 1022, MINNEAPOLIS, MN, 55440-1022, US

(73) Assignee: CARL ZEISS MICROIMAGING GMBH, Jena (DE)

(21) Appl. No.: 12/727,802

(22) Filed: Mar. 19, 2010

(30) Foreign Application Priority Data
Apr. 3, 2009 (DE) 102009015909.6

(51) Int. Cl. G01J 3/28; G01N 21/00

(52) U.S. Cl. 356/326; 356/432

(57) ABSTRACT

A method for the characterization of a silicon layer on a translucent substrate, in particular, for the characterization of a solar cell blank, includes detecting by at least one optical detector, the light transmitted through the silicon layer and/or reflected on the silicon layer. The method also includes determining a degree of absorption of the silicon layer for at least one wavelength by means of the detected light. The method further includes determining a quantity ratio between an amorphous fraction and a crystalline fraction of the silicon layer or between one of these fractions and the total of these fractions by means of the degree of absorption.

### CROSS-REFERENCE TO RELATED APPLICATIONS

This application claims benefit under 35 U.S.C. §119 to German Patent Application No. 10 2009 015 909.6, filed Apr. 3, 2009, the entire contents of which are hereby incorporated by reference.

### FIELD

The disclosure relates to a method and a device for the characterization of a thin silicon layer on a translucent substrate, especially for the characterization of a solar cell blank.

### BACKGROUND

Thin-layer solar cells are generally fabricated on glass sheet substrates. For this, thin layers of silicon (Si) are deposited on the substrates in high-vacuum processes. These layers typically have thicknesses of 100 nm to 1000 nm. After being deposited, the silicon is generally in the form of amorphous, i.e., noncrystalline, silicon. By thermal treatment, or so-called tempering, at temperatures of 600° C. to 700° C., the amorphous silicon (a-Si) is transformed partly or entirely into crystalline silicon (c-Si). The quantity ratio of these two states (amorphous to crystalline or vice versa) is thus an important technological parameter for the performance capability of the resulting solar cell, which can only vary within certain limits depending on the type of cell and therefore needs to be monitored continually in the fabrication process. For example, the quantity ratio can have effects on the efficiency of the solar cell.

In the prior art, U.S. Pat. No. 6,657,708 B1 (DE 699 30 651 T2) describes the optical characterization of a thin silicon layer by simultaneous execution of a Raman scattering spectrometry measurement and a (reflectometric) ellipsometry measurement. It is proposed to determine the crystalline fraction, i.e., the quantity ratio of amorphous and crystalline silicon, via Raman scattering spectrometry. Furthermore, thickness and surface relief of the silicon layer can be determined in the reflected light via ellipsometry, i.e., by the change in polarization properties.

This form of optical characterization has the drawback that the Raman spectrometry is slow and cumbersome, since extremely low intensities of scattered light have to be detected and, what is more, the accuracy of the measurement depends greatly on the relative position and geometrical orientation of sample and detector. Hence, the described method is little suited to a repeat measurement during a continuous fabrication process (“in line”) or the continued inspection of large-area silicon layers, since the geometrical orientation is not constant here and only a short measurement time is available. Therefore, in practice, Raman spectrometry is used exclusively in the laboratory for the investigation of random samples.

The same drawbacks apply to an even greater extent to the method of X-ray diffraction known in the prior art. Furthermore, the devices available for this are bulky, due to the principle involved, and the checking of large-area samples is hard to carry out.

### SUMMARY

The problem on which the disclosure is based is to indicate a method and a device for the characterization of a thin silicon layer on a translucent substrate, in particular, for the characterization of a solar cell blank, by which the optical characterization is possible in a brief time and with little sensitivity as regards relative changes in position or orientation. In particular, it should make possible the characterization of large-area products that are moving continually with a high throughput rate.

The problem is solved by a method having the features indicated in claim 1, and by a device having the features indicated in claim 8.

Advantageous embodiments of the disclosure are indicated in the subclaims.

The absorption of light in matter is described by the Lambert-Beer law: I_{Res}=I₀·e^{-αd}, where I₀ is the original light intensity, d is the thickness of material through which the light passes, I_{Res} is the residual intensity after the light has passed through the material, and α is the coefficient of absorption of the material.

According to the disclosure, it had been learned that great differences in the absorption of light exist between the two physical states (amorphous, crystalline) of silicon in the case of a thin silicon layer, especially thin-layer solar cell blanks, so that by measuring a degree of absorption of light one can optically characterize the composition of the silicon layer in terms of physical states in less time than with the prior art and with less sensitivity to relative changes in position and/or orientation between detector and sample.

Accordingly, it is proposed to carry out the following steps for the characterization of a thin silicon layer:
detecting by at least one optical detector the light transmitted through the silicon layer and/or reflected on the silicon layer,
determining of a degree of absorption of the silicon layer for at least one wavelength by the detected light, and
determining of a quantity ratio between an amorphous fraction and a crystalline fraction of the silicon layer by the degree of absorption (and a thickness of the silicon layer) or between one of these fractions and the total of these fractions by the degree of absorption (and a thickness of the silicon layer). It is advisable for the quantity ratio to then be put out as a characteristic signal or to be further processed without being put out. The method can also involve the controlling of a light source for illumination of the silicon layer during the detection.

As the degree of absorption in the sense of the disclosure, one will use any quantity that describes the strength of the absorption of light of a given wavelength in the thin layer, such as a coefficient of absorption or a quotient of an intensity of illumination and an intensity of transmission (or an intensity of illumination and one of reflection), or vice versa. As the quantitative ratio, one will use any quantity that describes the relative amounts of amorphous and crystalline silicon or the relative fraction of one physical state in the overall amount of silicon through which the light has passed, such as a ratio of material quantity, of concentration, or of mass of amorphous to crystalline silicon or vice versa.

A device according to the disclosure for characterization of a thin silicon layer on a translucent substrate, in particular, for the characterization of a solar cell blank, has at least one optical detector for detecting the light transmitted through the silicon layer and/or the light reflected at the silicon layer, as well as a controller to carry out the above steps of the method. The device can advantageously have a light source for illuminating the silicon layer during the detection process. For example, one can use the method described in DE 195 28 855 A1, whose disclosure content is incorporated here in its full extent, or the device described therein, for the illumination, detection of light, and determination of the degree of absorption.

For example, the quantity ratio can be determined while ascertaining the degree of absorption for only a single wavelength, or, more precisely, in a single narrow wavelength range, by comparing the degree of absorption with values previously saved in a table for a series of different quantity ratios at given wavelength and layer thickness, in particular, interpolating between such values. No complex mathematical operations are involved. In this case, however, a measurement of the layer thickness is first desirable. This can be done, for example, at the same single wavelength before the tempering of the silicon layer, as long as the silicon layer is still completely amorphous. Since the coefficient of absorption is known here, one can derive the layer thickness from the Lambert-Beer Law by a determination of the degree of absorption. Alternatively, the layer thickness can be determined from an interference spectrum detected in the VIS-NIR range. The interference spectrum, due to the slight thickness of the silicon layer, is the result of the partial reflection of the illuminating light at the layer boundaries. Its makeup depends on the layer thickness, so that the thickness can be ascertained from the spectrum.

Especially preferred are embodiments in which the determination of the degree of absorption, which is used to determine the quantity ratio, is done for one wavelength (or more precisely, a narrow wavelength range) of visible light. In the sense of the disclosure, visible light is electromagnetic radiation comprising one or more wavelengths between 380 nm and 750 nm. In visible light, the absorption differences between a-Si and c-Si are so great that a high accuracy is made possible for the quantity ratio being determined. Preferably, a wavelength is used between 450 nm and 680 nm, more preferably a wavelength between 500 nm and 660 nm. In these intervals, the differences in the absorption functions are especially large, so that an even higher accuracy can be achieved for the quantitative ratio.

In addition to or alternatively to the measurement of one or more degrees of absorption in the visible wavelength range, it is also possible to determine one or more degrees of absorption in the ultraviolet wavelength range (wavelengths less than 380 nm) and/or in the infrared wavelength range (wavelengths more than 750 nm) and use this to determine the quantitative ratio of the physical states of silicon.

Preferably, a spectrometer is used as the optical detector and one degree of absorption is determined for each of several wavelengths, with the quantitative ratio being determined by several of these degrees of absorption. The use of several degrees of absorption of a corresponding number of wavelengths allows one to determine the quantity ratio of the physical states with higher accuracy since, for example, errors caused by interference or other artifacts are lessened in this way. As the spectrometer, one can use, for example, the optical measurement device described in DE 100 10 213 A1, whose disclosure content is hereby fully incorporated. In particular, the quantity ratio can be determined exclusively by degrees of absorption determined for wavelengths of visible light.

Advantageously, in addition to the quantity ratio, a thickness of the silicon layer can be determined and in particular output by several degrees of absorption. In this way, one can do without a separate measurement, enabling a simultaneous monitoring of composition and thickness of a thin silicon layer. The measurement device is thus simplified with respect to the prior art. For example, it is possible to determine the layer thickness from a multichannel-detected interference spectrum in the VIS-NIR range.

Advantageously, a degree of hydrogen doping in amorphous silicon can be determined and in particular output as a characteristic signal, in addition to or instead of the quantitative ratio by the degree of absorption or by several degrees of absorption. The degree of hydrogen doping, like the composition of the silicon layer, constitutes a technological parameter of the fabrication process that should be monitored in certain circumstances. For example, it has influence on the electrical conductivity of the silicon layer. The measurement and monitoring is possible with high accuracy and in brief time. Once again, the different absorption behavior for hydrogen-doped and undoped silicon in the spectral range between around 900 nm and 1200 nm is used to ascertain the degree of doping from the degree of absorption (or several degrees of absorption). This can also be achieved by a Lambert-Beer equation for one wavelength, or a system of such equations for several wavelengths.

Preferably, the steps of the method are repeated at another location on the silicon layer, in particular, after or during a movement of the substrate and the silicon layer relative to the detector by a transport device. This enables the measurement and monitoring of local quantitative ratios on large-area samples in a continual process. The local measurement results and indication of the location relative to the sample at the same time constitute a mapping of the large-area sample. In this way, for example, one can separate sample regions with different properties and process them differently in the further course of the fabrication or distribution. The device according to the disclosure preferably has a transport device for the movement of the substrate and the silicon layer relative to the detector. Preferably, a control of the transport device is connected to the controller, and the controller detects light relative to movement of the transport device. The measurement as a function of the movement allows one to determine the spatially resolved quantity ratio with high accuracy in the shortest time, and thus to output the quantity ratio as a function of the location on the sample (the substrate).

The main goal of the disclosure is the fabrication of solar cells, the silicon layer and the substrate being parts of a solar cell blank.

The disclosure also comprises a computer program and a controller, which are outfitted to carry out a method according to the disclosure. In particular, the outfitting is done modularly with the following modules:
a software module for the detection of the light transmitted through the silicon layer and/or reflected on the silicon layer by at least one optical detector,
a software module for determining a degree of absorption of the silicon layer for at least one wavelength by the detected light, and
a software module for determining of a quantity ratio between an amorphous fraction and a crystalline fraction of the silicon layer or between one of these fractions and the total of these fractions by the degree of absorption.

In addition, a software module can be provided for controlling a light source for the illumination of the silicon layer during the detection process. A software module can also be provided for outputting the quantitative ratio as a characteristic value. Several or all of the above-enumerated software modules can be designed as a common software module.

In especially preferred embodiments of the device according to the disclosure, the detector is arranged on a cross beam and can be displaced relative to the silicon layer. This makes possible the measurement of large-surface products at any given point with high throughput rate. Optionally, several detectors can be arranged staggered along the cross beam for the simultaneous detection of light at several points. In this way, the throughput rate of the process monitoring can be increased.

Advisedly, the detector is configured as a spectrometer for the measurement of several degrees of absorption of different wavelengths.

The illumination of the silicon layer is preferably done by a collimation optics.

Advantageously, a second optical detector can be provided, the first detector being arranged to detect transmitted light and the second detector to detect reflected light. The simultaneous measurement in transmission and reflection enables a higher accuracy in determining the characteristic quantity ratio.

Especially for thin layers with slight absolute absorption, one advantageously arranges at least one mirror for deflecting the light being detected such that it passes through the silicon layer several times in succession.

### BRIEF DESCRIPTION OF THE DRAWINGS

The disclosure will now be explained more closely via sample embodiments.

The drawings show:

FIG. 1, a device for characterization of a thin-layer solar cell blank,

FIG. 2, a flow chart of the characterization method,

FIG. 3, measurement results for degrees of transmission of diffuse illuminating light,

FIG. 4, measurement results for degrees of transmission of collimated illuminating light,

FIG. 5, an alternative device with exclusively collimated light, and

FIG. 6, another alternative device with multiple absorption.

In all drawings, the same parts bear the same reference numbers.

### DETAILED DESCRIPTION

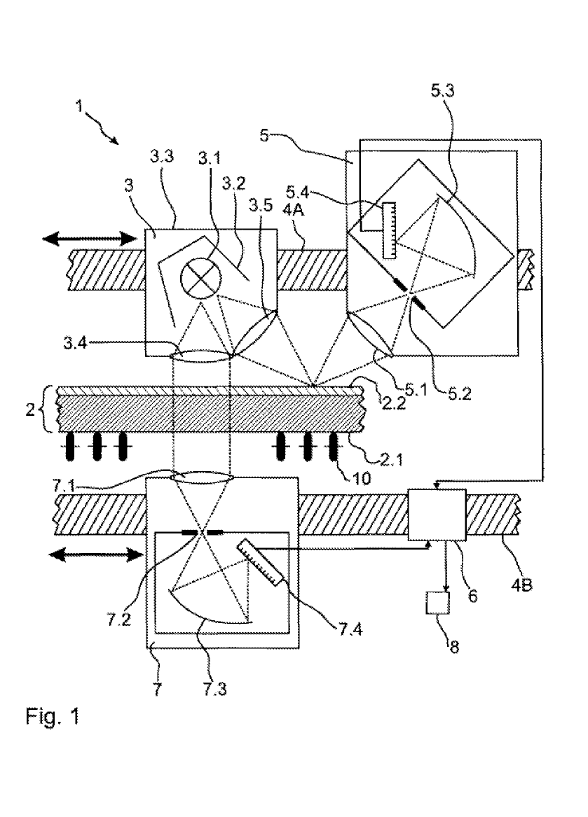

FIG. 1 shows, merely as an example, a schematic representation of a device 1 for characterization of a thin-layer solar cell blank 2, consisting of a transparent glass substrate 2.1 and a thin silicon layer 2.2. Above the solar cell blank 2 is arranged a light source 3 for illuminating the solar cell blank 2, able to slide on a cross beam 4 (A+B), comprising two parts 4A and 4B rigidly joined together. The light source 3 comprises, e.g., a halogen lamp 3.1, a reflector 3.2 for boosting its efficiency, and a housing 3.3, in which the optics 3.4 and 3.5 are fitted. The halogen lamp emits, for example, ultraviolet (UV), visible (VIS) and infrared (IR) light in a wavelength range of 350 nm to 2200 nm. The first optics 3.4 is a collimation optics to form a parallel pencil of rays, which passes through the silicon layer 2.2 and the substrate 2.1. The pencil of rays has, for example, a diameter of around 2 mm. On the contrary, the second optics 3.5 is configured and arranged such that the illuminating light of the lamp 3.1 is focused in the silicon layer 2.2, and the measurement spot has a diameter of around 2 mm, for example. In the portion of the illuminating light that is reflected at the silicon layer 2.2 is arranged a first detector 5 in the form of a spectrometer measuring head, likewise able to slide on the cross beam 4, and having a fixed positional relationship to the light source 3. The detector has, for example, an entrance optics 5.1, a slit 5.2, an imaging grating 5.3 and a one-dimensional spatial resolution optoelectronic receiver 5.4, for example in the form of a CCD row or a photodetector field (English: “photo diode array,” PDA) with, say, 32 elements, while the entrance optics 5.1 images the place of reflection in the silicon layer 2.2 onto the slit 5.2.

Beneath the solar cell blank 2, in the transmitted light of the light source 3, a second detector 7 in the form of another spectrometer measuring head is likewise fastened to the cross beam 4, with this also having a fixed positional relation to the light source 3. Advisedly, the second detector 7 is constructed for the most part identical to the first detector 5 and it has a slit 7.2, an imaging grating 7.3 and a one-dimensional spatial resolution optoelectronic receiver 7.4, while the entrance optics 7.1 focuses the collimated beam onto the slit 7.2. The two receivers 5.4, 7.4 are electrically connected via flexible cable, e.g., for data transmission, to a controller 6, which is likewise fastened to the cross beam 4, for example. The cross beam 4 encloses the solar cell blank 2, which is mounted in a transport device, such as a roll table with rollers 10, and is able to move through between the cross beam parts 4A, 4B. The light source 3 and the detectors 5, 7 can slide together along the cross beam 4, e.g., for the movement capability. The spectrometers are advisedly calibrated before the start of the measurement, either with air as the calibrating medium or by one or more standards (bright/white, dark/black) in place of the solar cell blank 2. The gratings 5.3 and 7.3 serve to image the respective slit 5.2/7.2 onto the particular receiver 5.4/7.4, whereupon the impinging light is spatially-spectrally split up, so that the spatial resolution of the receiver enables a spectral resolution into 32 wavelength regions, in the case of 32 elements. The controller 6 ascertains from the detected light intensities corresponding degrees of absorption for several or all of the wavelength regions resolved with the receivers 5.4/7.4, from which it determines a quantitative ratio of c-Si and a-Si and outputs this as a characteristic signal. For the transmission of the characteristic signal, it is connected to an output unit 8, which outputs a warning, for example, dependent on the characteristic signal, when a given composition of the silicon layer 2.2 is not maintained. The setpoint can consist of the boundary points of a value range of an acceptable quantitative ratio, for example.

In alternative embodiments (not shown), only one first detector 5 or only one second detector 7 (without the first detector 5) can also be arranged for the measurement either in transmission or in reflection. It is possible to provide diffuse illumination for the transmitted light measurement both with one or also with two detectors, and the respective entrance optics should be set up accordingly. It is also possible to use two separate light sources for transmitted light and reflected light measurement. Generally speaking, the spectrometers can be designed in detail as in DE 100 10 213 A1, for example. Also any other detector configuration can be used. Alternatively to a two-part cross beam 4 (A+B), which can be configured as one or more pieces, separate cross beams 4A, 4B can be used for the light source 3 and the second detector 7. Also, a separate cross beam (not shown) can be used for the first detector 5. In all cases, a fixed relative positional relation and relative orientation between detector(s) and light source(s) should be assured. In all embodiments it is possible to measure either reflected light alone or transmitted light alone or both of them. One can then forgo a second illuminating optics.

In one special embodiment of the device 1, an optical waveguide with series-connected input optics is arranged in front of the light source 3 for direct detection of reference light (not shown; for a particular configuration, reference is made to DE 100 10 213 A1 or DE 195 28 855 A1, for example). In this way, one can forgo a separate calibration of the device 1.

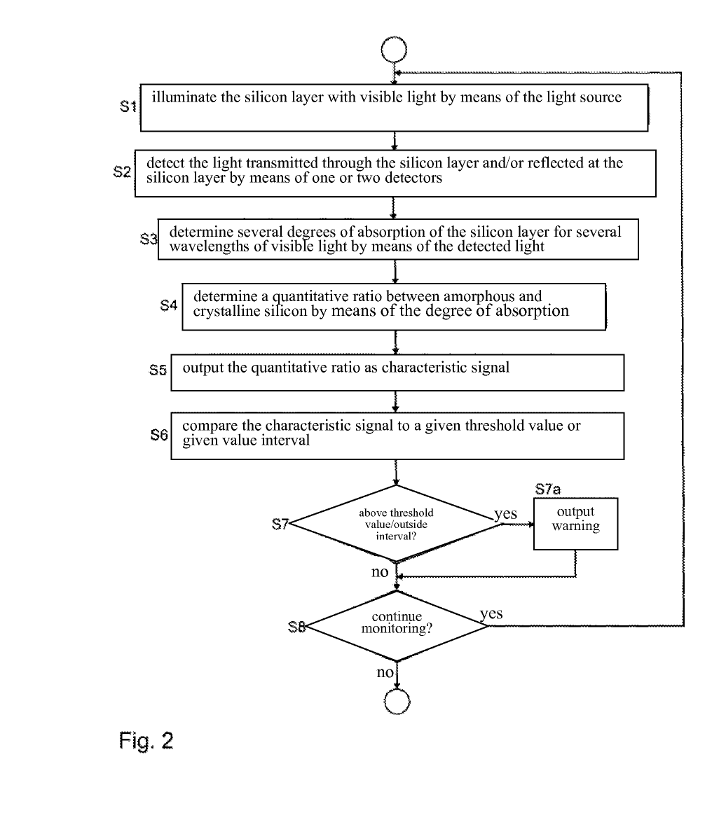

The controller 6 carries out the method shown schematically in FIG. 2, for example, to characterize the solar cell blank 2 by its composition from the physical states of silicon while the solar cell blank 2 moves perpendicular to the cross beam 4 in the fabrication process. The silicon layer 2.2 will be illuminated by the light source 3, for example, permanently or only during a light detection process (step S1). During this process, light is detected from the silicon layer 2.2 by the detectors 5, 7 (or alternatively with only a single detector 5 or 7) (step S2). With the reflection detector 5, reflected light is detected; with the transmitted light detector 7, transmitted light is detected. In either case, the light is detected broken down into wavelengths, due to the spatial-spectral decomposition in the detector's own spectrometer, so that intensities can be detected simultaneously for several wavelengths. A measurement duration of, say, 50 ms for a single measurement is enough for a sufficiently precise characterization of the composition, and a single measurement in this context includes all simultaneously detectable wavelengths.

Next, a degree of absorption is determined from the measured intensities of the detected light for several wavelengths, in particular, for both the reflection measurement and for the transmitted light measurement (step S3). Alternatively, the degrees of absorption can be determined only by a reflection measurement or only by a transmitted light measurement. For example, let us assume that three degrees of absorption A_{i, R/T} (i=1, 2, 3) were determined for three different wavelengths λᵢ. A given degree of absorption can be determined, for example, by forming a quotient from the measured transmitted (or reflected) intensity I_{Res, R/T} and the original intensity I_{0, R/T} of the illuminating light of the light source 3 ascertained in the calibration (or by reference light) at the location of the detector 5 (or 7):

$${A}_{i , R / T} = \frac{{I}_{Res , R / T} ( {λ}_{i} )}{{I}_{0 , R / T (} {λ}_{i} )} .$$

The degrees of absorption from transmission and reflection can then (if determined) be weight-averaged for further evaluation, so that an individual degree of absorption Aᵢ results for each wavelength.

Using the determined degrees of absorption Aᵢ, the controller 6 determines a quantitative ratio between the amorphous and crystalline silicon states (step S4). This is done in different ways. For example, degrees of absorption resulting for a plurality of layer thicknesses, a plurality of quantity ratios and a plurality of wavelengths are set forth in look-up tables (LUT), for example, in a read-only memory (ROM), which the central processing unit (CPU) of the controller can access (not shown). Thus, there is a table in which a resulting value (degree of absorption) is coordinated with a combination of three parameters (layer thickness, quantity ratio, wavelength) each time. The central processing unit searches in the look-up table for the best-fitting combination of parameters for the determined set of degrees of absorption Aᵢ. Advantageously, it can interpolate between the table entries in order to determine the quantity ratio q of the physical states of the silicon.

One preferred method for determining the quantity ratio q is to form Lambert-Beer equations Aᵢ=·e^{-αid}, where α, is the particular coefficient of absorption of the respective wavelengths, which is approximately composed of the fractions of amorphous and crystalline silicon according to αᵢ=q_{α}α_{α,i}+q_{c}α_{c,i} with q_{α}+q_{c}=1, q_{α} being the fraction of amorphous silicon (in terms of mass, volume or material quantity) and q_{c} being the fraction of crystalline silicon (in terms of mass, volume or material quantity). The coefficients of absorption α_{α,i} α_{c,i} for amorphous silicon and for crystalline silicon are assumed to be a priori information depending on the wavelength and can be ascertained, for example, with calibration steps from entirely amorphous and entirely crystallized silicon. By solving the equations ln Aᵢ=−(q_{α}α_{α,i}+(1−q_{α})α_{c,i})·d, the fractions of the physical states can be determined for each wavelength and, for example, be inserted separately for each wavelength into the ratio q=q_{c}/qₐ=(1-qₐ)/qₐ and from this a (preferably weighted) average can be determined.

The material thickness d should either be measured separately beforehand or it can advantageously be determined by ascertaining at least one additional degree of absorption A for one additional wavelength as the unknown in a system of several Lambert-Beer equations.

For example, for a wavelength of λ=600 nm and a layer thickness of d=200 nm, the coefficient of absorption for a-Si is αₐ=1×10⁵ cm⁻¹ and the coefficient of absorption for c-Si is α_{c}=5×10³ cm⁻¹. From this one gets:
for and

$$\begin{matrix}a \text{-} Si , {A}_{a , T} = \frac{{I}_{Res}}{{I}_{0}} \\ = exp ( - 1 \times {10}^{5} \times 200 \times {10}^{- 7} ) \\ = 0.135 ( transmission of 13.5 \% )\end{matrix}$$

for

$$\begin{matrix}c \text{-} Si , {A}_{c , T} = \frac{{I}_{Res}}{{I}_{0}} \\ = exp ( - 5 \times {10}^{3} \times 200 \times {10}^{- 7} ) \\ = 0.90 ( transmission of 90 \% ) .\end{matrix}$$

For example, a transmission (degree of transmission) of A_{T}=50% is measured at 600 nm. From this, one gets an effective coefficient of absorption of α=−(In(0.5)/200×10⁻⁷)=3.5×10⁴ cm⁻¹, from which the fractions of a-Si (q_{A}) and c-Si (q_{C}) can be calculated:

A_{T}=α×d=(q_{A}×α1+q_{C}×α2)×d; α=q_{A}×α_{A}+q_{C}×α_{C} with q_{C}=1−q_{A}

α=A_{T}×α_{A}+(1−A_{T})×α_{C}

α=A_{T}×α_{A}+α_{C}−A_{T}×α_{C}

A_{T}=(α−α_{C})/(α_{A}−α_{C})

Inserting the above values, one gets:

$$\begin{matrix}{q}_{A} = \frac{( 3.5 \times {10}^{4} {cm}^{- 1} - 5 \times {10}^{3} {cm}^{- 1} )}{( 1 \times {10}^{5} {cm}^{- 1} - 5 \times {10}^{3} {cm}^{- 1} )} \\ = 0.316 ⇒ {q}_{C} \\ = 0.684 ;\end{matrix}$$

$$q = {q}_{C} / {q}_{A} = 2.16$$

Thus, at the investigated point there is a fraction (quantity ratio to the entire amount of silicon transmitting the light) of 31.6% of a-Si and, accordingly, a fraction of 68.4% of c-Si. The quantity ratio of crystalline to amorphous silicon in the amount of silicon transmitting the light is 2.16:1.

Alternatively, a chemometric assay of principal components can also be done to determine the quantity ratio.

The quantity ratio q (or one or both of the quantity ratios q_{A} or q_{c}) determined in this way is put out by the controller 6 as a characteristic signal for further processing to a software or hardware module (not shown) (step S6) or evaluated by the controller itself For example, a comparison is made with a given value range (step S7). If the determined value q does not lie in the given value range, a warning is output. Alternatively, the comparison could be done with one of the quantity ratios q_{A} or q_{C}).

The disclosure makes use of the differing absorption functions of light in thin layers of crystalline or amorphous silicon dependent on the wavelength. Thus, for example, a 400 nm thick layer of a-Si absorbs over 99.99% of the illuminating light at a wavelength of 500 nm, while the absorption in the case of c-Si is only around 45%. At a wavelength of 600 nm, the absorption is around 98% for a-Si and around 19% for c-Si; at a wavelength of 700 nm, the absorption is around 78% for a-Si and around 9% for c-Si.

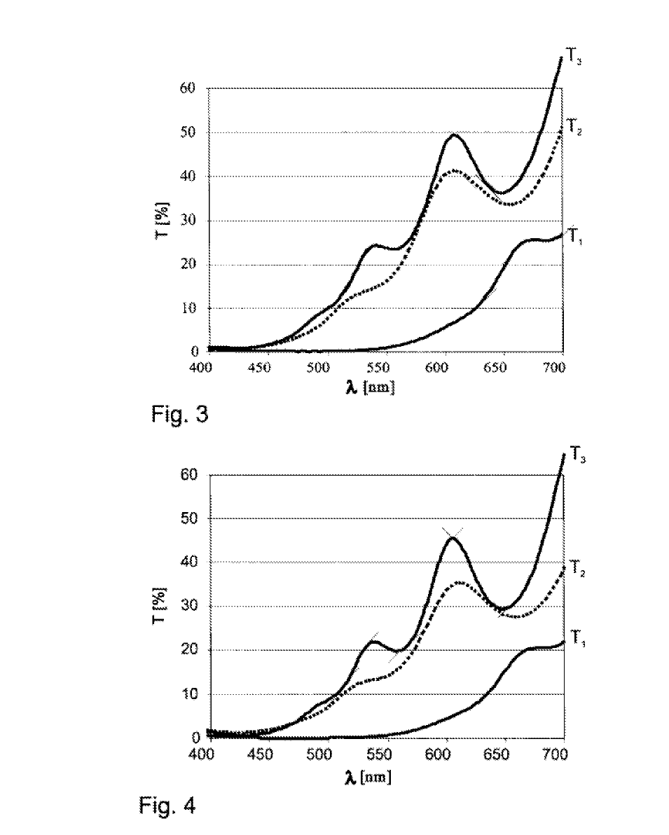

FIG. 3 shows experimentally measured degrees of transmission using the example of a transmission with diffuse light, and FIG. 4 shows the example of a transmission with collimated light. In both cases, the same samples were investigated. Raman measurements were used to verify that the sample whose degrees of transmission are represented by the lowest curve T₁ has only amorphous silicon. The middle curve T₂ represents the degrees of transmission of a sample showing amorphous and crystalline fractions in the Raman spectrum. The upper curve T₃ represents the degrees of transmission of a sample having only crystalline silicon.

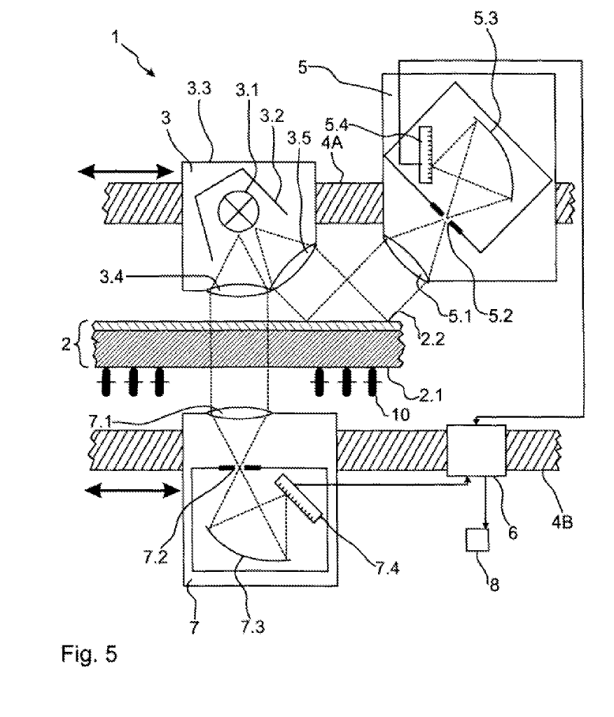

FIG. 5 illustrates another possibility for the construction of a device according to the disclosure, also known as transflection, in which parallel light is used both for the measurement in reflected light by the first detector 5 and for the measurement in transmitted light by the second detector 7. For this purpose, the optics 3.4 and 3.5 are designed as collimation optics.

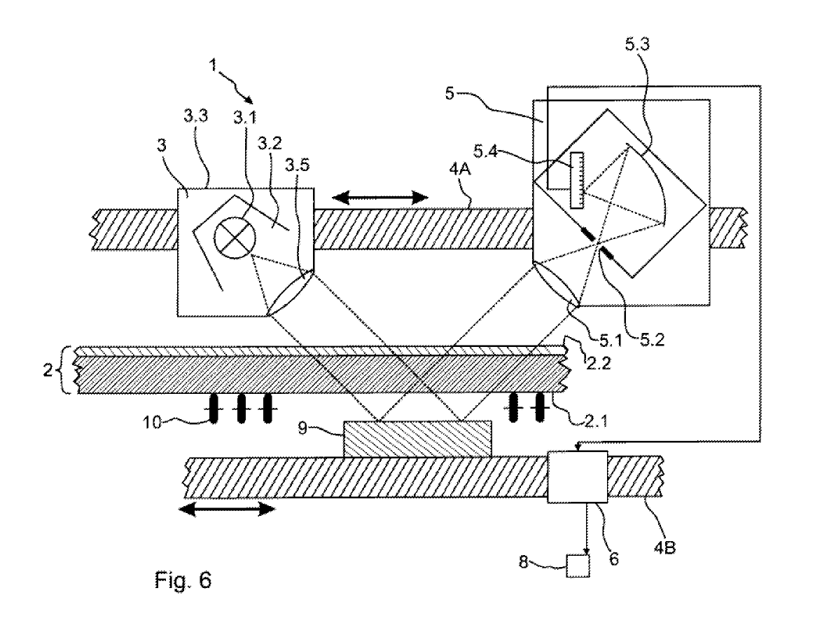

FIG. 6 shows a further embodiment in which a multiple passage of the illuminating light through the silicon layer 2.2 and the substrate 2.1 occurs. For this purpose, a mirror 9 is arranged underneath the solar cell blank 2 so that it reflects the collimated illuminating light to the detector 5. Despite the interim reflection, this is a measurement of transmitted light. Accordingly, the effective thickness of material of the silicon layer 2.2 through which the light passes is increased by a factor of two. In further embodiments (not shown), several mirrors 9 can be arranged (above and below the solar cell blank 2) to guide the illuminating light even more times through the solar cell blank 2 by several interim reflections before it impinges on the detector 5. Thanks to such multiple pathways and absorption, even very thin silicon layers can be investigated with high precision and a quantity ratio determined for their composition. This is especially expedient when using wavelengths at which the absolute absorption is low, regardless of the physical state.

In all embodiments, instead of a horizontal orientation of the solar cell blank 2 (or any other product being measured), one can specify, for example, a vertical orientation or any other kind. The arrangement of the light source 3 and the detectors 5 and 7 or the detector 5 or 7 should be adapted accordingly. The transport device should also be adapted accordingly, for example, in the case of a roll table, by having guide rollers arranged on either side of the blank 2.

In the various ways described, one can analyze solar cells or other comparable specimens up to a size of several square meters in the fabrication process, the typical measurement time per measurement point being 20 ms to 100 ms. In addition, the thickness of the silicon layer can be determined and output and/or monitored. This further simplifies the monitoring of the fabrication.

### LIST OF REFERENCE NUMBERS

1 device for optical characterization
2 solar cell blank
2.1 glass substrate
2.2 silicon layer
3 light source
3.1 halogen lamp
3.2 reflector
3.3 housing
3.4 first illuminating optics
3.5 first illuminating optics
4 cross beam (A, B)
5 first detector
5.1 entrance optics
5.2 slit
5.3 imaging grating
5.4 optoelectronic receiver
6 controller
7 second detector
7.1 entrance optics
7.2 slit
7.3 imaging grating
7.4 optoelectronic receiver
8 output unit
9 Mirror
10 roller

What is claimed is:

1. A method of characterizing a silicon layer on a translucent substrate, comprising:
using an optical detector to detect light transmitted through the silicon layer and/or light reflected by the silicon layer;
using the detected light to determine a degree of absorption by the silicon layer for at least one wavelength of the light; and
using the degree of absorption by the silicon layer to determine at least one ratio selected from the group consisting of:
a) a ratio of an amorphous fraction of the silicon layer to a crystalline fraction of the silicon layer;
b) a ratio of the amorphous fraction of the silicon layer to a total of the crystalline and amorphous fractions of the silicon layer; and
c) a ratio of the crystalline fraction of the silicon layer to the total of the crystalline and amorphous fractions of the silicon layer.

2. The method of claim 1, wherein the silicon layer is an element of a solar cell blank.

3. The method of claim 1, wherein the degree of absorption by the silicon layer is used to determine the ratio of the amorphous fraction of the silicon layer to the crystalline fraction of the silicon layer.

4. The method of claim 1, wherein the degree of absorption by the silicon layer is used to determine the ratio of the amorphous fraction of the silicon layer to the total of the crystalline and amorphous fractions of the silicon layer.

5. The method of claim 1, wherein the degree of absorption by the silicon layer is used to determine the ratio of the crystalline fraction of the silicon layer to the total of the crystalline and amorphous fractions of the silicon layer.

6. The method of to claim 1, wherein the at least one wavelength comprises a wavelength of visible light.

7. The method of claim 1, wherein the optical detector is a spectrometer, the degree of absorption is determined for each of several wavelengths, and the at least one ratio is determined based on several of the wavelengths of absorption.

8. The method of claim 7, wherein at least one of the wavelengths of absorption corresponds to visible light.

9. The method of claim 7, wherein a thickness of the silicon layer is determined based on the wavelengths of absorption.

10. The method of claim 1, wherein the degree of absorption of the silicon layer can be used to determine a degree of hydrogen doping in amorphous silicon in the silicon layer.

11. The method of claim 1, performing the method at least two different locations of the silicon layer.

12. A computer program product tangibly embodied in an information carrier and comprising instructions that when executed by a processor perform a method comprising:
using an optical detector to detect light transmitted through the silicon layer and/or light reflected by the silicon layer;
using the detected light to determine a degree of absorption by the silicon layer for at least one wavelength of the light; and
using the degree of absorption by the silicon layer to determine at least one ratio selected from the group consisting of:
a) a ratio of an amorphous fraction of the silicon layer to a crystalline fraction of the silicon layer;
b) a ratio of the amorphous fraction of the silicon layer to a total of the crystalline and amorphous fractions of the silicon layer; and
c) a ratio of the crystalline fraction of the silicon layer to the total of the crystalline and amorphous fractions of the silicon layer.

13. A system, comprising:
a computing device, comprising:
a memory configured to store instructions; and
a processor configured to execute the instructions to perform a method comprising:
using a first optical detector to detect light transmitted through the silicon layer and/or light reflected by the silicon layer;
using the detected light to determine a degree of absorption by the silicon layer for at least one wavelength of the light; and
using the degree of absorption by the silicon layer to determine at least one ratio selected from the group consisting of:
a) a ratio of an amorphous fraction of the silicon layer to a crystalline fraction of the silicon layer;
b) a ratio of the amorphous fraction of the silicon layer to a total of the crystalline and amorphous fractions of the silicon layer; and
c) a ratio of the crystalline fraction of the silicon layer to the total of the crystalline and amorphous fractions of the silicon layer.

14. The system of claim 13, comprising the first optical detector.

15. The system of claim 14, wherein the first optical detector is in a cross-beam.

16. The system of claim 14, wherein the first optical detector is a spectrometer.

17. The system of claim 14, further comprising collimation optics configured to illuminate the silicon layer with collimated light.

18. The system of claim 14, further comprising a second optical detector, wherein the first optical detector is configured to detect light that is transmitted by the silicon layer, and the second optical detector is configured to detect light that is reflected by the silicon layer.

19. The system of claim 14, further comprising a transport device configured to move the silicon layer relative to the first optical detector.

20. The system of claim 19, wherein the computing device is configured to control the transport device, and the detection of the light is dependent on movement of the transport device.

21. The system of claim 14, further comprising a mirror configured to deflect light so that the light passes through the silicon layer multiple times before being detected.
